(19) United States
(12) Patent Application Publication
(10) Pub. No.: US 2026/0233169 A1
(43) Pub. Date: Aug. 13, 2026

(54) METHOD FOR MANUFACTURING A FREE STANDING MEMBRANE AND METHOD FOR FORMING AN ELECTROPLATED LAYER USING A FREE STANDING MEMBRANE

(71) Applicant: Korea Advanced Institute of Science and Technology, Daejeon (KR)

(72) Inventors: Taek-Soo Kim, Daejeon (KR); Dong Jun Kim, Daejeon (KR); Yonghwi Kim, Daejeon (KR)

(21) Appl. No.: 19/457,046

(22) Filed: Jan. 22, 2026

(30) Foreign Application Priority Data
Feb. 10, 2025 (KR) 10-2025-0016907

(51) Int. Cl. B01D 67/00; B01D 69/12; C25D 5/56

(52) U.S. Cl. CPC B01D 67/0083; B01D 67/00933; B01D 67/0095; B01D 69/12; C25D 5/56

(57) ABSTRACT

A method for manufacturing a free-standing membrane may include transferring a membrane and growing a grain. In the transferring a membrane, a membrane may be transferred onto a first substrate provided with a penetration hole to provide a free-standing area in the membrane, the free-standing area overlapping with the penetration hole. In the growing a grain, a size of a grain in the free-standing area may be increased.

### CROSS-REFERENCE TO RELATED APPLICATION

The present application claims priority to and the benefit of Korean Patent Application No. 10-2025-0016907, filed on February 10, 2025, in the Korean Intellectual Property Office, and all the benefits accruing therefrom under 35 U.S.C § 119, the contents of which are incorporated herein in its entirety by reference.

### BACKGROUND

### 1. Field

The present disclosure relates to a method for manufacturing a free standing membrane. More particularly, the present disclosure relates to a method for manufacturing a free-standing membrane and a method for forming an electroplated layer using a free-standing membrane, the free-standing membrane provided with a free-standing area that is not directly supported by a substrate.

### 2. Description of the Related Art

A functional membrane is widely used in various fields, such as water purification, low-energy desalination, high-permeability and selective gas separation, cell co-culture, and pellicle for extreme ultraviolet (EUV) lithography. In particular, an ultra-thin membrane having a nanometer-scale thickness exhibits a fast liquid diffusion rate and high optical transparency, making it applicable to high value-added industries such as biotechnology and semiconductor. Accordingly, the ultra-thin membrane having a nano-scale thickness is highly valuable.

Conventionally, technologies of semiconductor or micro-electromechanical system (MEMS) have mainly been used for manufacturing an ultra-thin film membrane.

For example, an ultra-thin membrane layer having a nanometer-scale thickness could be formed on a substrate by using technologies, such as physical vapor deposition (PVD), chemical vapor deposition (CVD), electroplating, spin-on-glass (SOG), or atomic layer deposition (ALD).

In addition, a free-standing membrane provided with a free-standing area not directly supported by a substrate could be manufactured by etching a portion of the substrate supporting the ultra-thin membrane layer through a chemical etching process after forming the ultra-thin membrane layer.

However, such conventional techniques are equipment-intensive and involve chemical etching processes. Accordingly, the techniques are disadvantageous in high manufacture costs and environmental treatment costs as well as long manufacturing times.

In addition, because the chemical etching process may cause chemical or mechanical defect as well as tensile or compressive residual stress in the ultra-thin membrane layer, the ultra-thin membrane layer may be easily damaged. As a result, it has been difficult to manufacture an ultra-thin membrane having a very small thickness using a conventional technique. For example, a wrinkle may form in the free-standing area of the membrane, and the free-standing area may only be manufactured with a very small area, for example, about 1 cm2.

### SUMMARY

Embodiments of the present disclosure provides a method for manufacturing a free-standing membrane and a method for forming an electroplated layer using a free standing membrane, the free-standing membrane provided with a free-standing area that is not directly supported by a substrate.

A method for manufacturing a free-standing membrane according to one aspect of the present disclosure may include transferring a membrane and growing a grain.

In the transferring a membrane, a membrane may be transferred onto a first substrate provided with a penetration hole to provide a free-standing area in the membrane, the free-standing area overlapping with the penetration hole in a planar view.

In the growing a grain, a size of the grain in the free-standing area may be increased.

According to one embodiment of the present disclosure, in the transferring a membrane, the membrane may be transferred onto the first substrate to cover the penetration hole.

According to one embodiment of the present disclosure, after the transferring a membrane, the free standing area and a substrate support area may be provided in the membrane, the substrate support area overlapping with the first substrate in a planar view.

According to one embodiment of the present disclosure, the growing a grain may include a heat treatment process, in which the membrane is heated and then cooled.

According to one embodiment of the present disclosure, a size of the grain in the free-standing area may be increased by the heat treatment, and the grains in the free-standing area may be aligned in a pre-determined direction.

According to one embodiment of the present disclosure, the method for manufacturing a free-standing membrane may further include preparing a substrate and preliminarily transferring.

In the preparing a substrate, a second substrate may be prepared, the membrane disposed on one side of the second substrate.

In the preliminarily transferring, the second substrate may be pushed into a liquid to transfer the membrane onto a surface of the liquid.

In the transferring a membrane, the membrane transferred onto a surface of the liquid may be scooped up by the first substrate to be transferred onto the first substrate.

According to one embodiment of the present disclosure, the method for manufacturing a free-standing membrane may further include drying.

In the drying, after the transferring a membrane and before the heat treatment process, the liquid remaining on the membrane may be evaporated and removed.

According to one embodiment of the present disclosure, a wrinkle in the free-standing area may be flattened through the heat treatment.

A method for forming an electroplated layer using a free-standing membrane according to another aspect of the present disclosure may include transferring a membrane, growing a grain, and electroplating.

In the transferring a membrane, a membrane may be transferred onto a first substrate provided with a penetration hole to provide a free-standing area in the membrane, the free-standing area overlapping with the penetration hole in a planar view.

In the growing a grain, a size of the grain in the free-standing area may be increased by a heat treatment process.

In the electroplating, after the heat treatment, an electroplated layer may be formed on the free-standing area.

According to one embodiment of the present disclosure, grains of the electroplated layer may be aligned in a direction substantially same with that of grains of the free-standing area.

According to one embodiment of the present disclosure, the present disclosure has advantages of lower manufacturing costs, elimination of a chemical etching process which avoids environmental treatment costs, and reduced product manufacture time.

In addition, an ultrathin membrane having a nanometer-scale thickness may be manufactured such that a free-standing area of very large size, such as with a diameter of 10 cm or more, is provided compared to a conventional technology.

As a size of the grain of the free-standing area increases, electrical resistance of the membrane may be reduced.

In addition, a defect or wrinkle that may be generated during a conventional process of forming a membrane layer or etching may be suppressed or eliminated.

In addition, mechanical strength of a membrane may be enhanced to allow formation of a functional layer on a free-standing area through, for example, spin coating, electroplating, or sputtering using the membrane as a base substrate.

Particularly, as grains in the free-standing area are grown through a heat treatment process and aligned in a predetermined direction, when an electroplated layer is formed on the free-standing area, grains forming the electroplated layer, that is, metal crystals, may also be formed with a large size and aligned in the predetermined direction. As a result, an electrical resistance of the electroplated layer may be reduced, corrosion resistance may be improved, and an electroplated layer in which crystals are aligned in a predetermined direction, similar to single-crystal copper, may be obtained.

### BRIEF DESCRIPTION OF THE DRAWINGS

These and/or other features will become apparent and more readily appreciated from the following description of the embodiments, taken in conjunction with the accompanying drawings in which:

FIG. 1 is a flow chart of a method for manufacturing a free-standing membrane according to one embodiment of the present disclosure;

FIG. 2 is an illustration of a second substrate on which a membrane is disposed on one surface thereof;

FIG. 3 is a modified example of FIG. 2;

FIG. 4 is an illustration for explaining a preliminary transfer step of a membrane shown in FIG. 2;

FIG. 5 is an illustration for explaining a preliminary transfer step of a membrane shown in FIG. 3;

FIG. 6 and FIG. 7 are illustrations for explaining a membrane transfer step for a membrane transferred onto surface of liquid;

FIG. 8 is a modified example of the first substrate shown in FIG. 6;

FIG. 9 is another modified example of the first substrate shown in FIG. 6;

FIG. 10 through FIG. 12 are illustrations for explaining a grain growth mechanism in the step of growing a grain;

FIG. 13 is an illustration for explaining effects of improving a wrinkle of a membrane by a heat treatment;

FIG. 14 is a flow chart of forming an electroplated layer using a free-standing membrane according to one embodiment of the present disclosure;

FIG. 15 is an illustration for explaining the step of electroplating of FIG. 14;

FIG. 16 is an illustration of a first substrate where an electroplated layer is formed on the membrane by electroplating; and

FIG. 17 is a cross-sectional view taken along the I-I line shown in FIG. 16.

### DETAILED DESCRIPTION

References will now be made in detail to certain embodiments, of which examples are illustrated in the accompanying drawings, where like reference numerals refer to like elements throughout. The embodiments may have a variety of forms and permutations, but the present disclosure shall by no means be construed as being limited to the described embodiments. Rather, the present disclosure shall be construed to encompass all forms, permutations, equivalents and substitutes covered by the technical ideas and scope of the present disclosure. Accordingly, the embodiments are merely described below, by referring to the figures, to explain features of the present disclosure.

Like or identical reference numerals refer to like or identical elements. Moreover, in the accompanying drawings, the thicknesses, ratios, and dimensions of the elements may not be to exact scale and may have been exaggerated for the benefit of effective explanation of the technical features associated with these elements. As such, the present disclosure shall not be restricted to the thicknesses, ratios, dimensions, etc. illustrated in the drawings.

When an element is described to be “disposed on,” “placed on,” “arranged on,” “connected to,” “coupled to,” “attached to” another element, it shall be construed as being disposed on, placed on, arranged on, connected to, coupled to, or attached to the other element directly but also as possibly having another element therebetween. On the other hand, if one element is described to be “directly disposed on,” “directly placed on,” “directly arranged on,” “directly connected to,” “directly coupled to,” or “directly attached to” another element, it shall be construed that there is no other element interposed therebetween.

Moreover, relative terms, such as “below,” “under,” “beneath,” “lower,” “bottom,” “above,” “over,” “upper,” “top,” etc., may be used herein to describe one element’s relationship to another element as illustrated in the accompanying figures. It shall be understood that relative terms are intended to encompass different orientations of the device in addition to the orientation depicted in the accompanying figures. For example, if the device in one of the figures is turned over, elements described as being on the “lower” side of the other elements would then be oriented on “upper” sides of the other elements. The exemplary term “lower” can therefore encompass an orientation of both “lower” and “upper,” depending on the particular orientation of the figure. Similarly, if the device in one of the figures is turned over, elements described as “below” or “beneath” other elements would then be oriented “above” the other elements. The exemplary term “below” or “beneath” can therefore encompass an orientation of both above and below.

Furthermore, when one device or layer is described to be “on,” “over,” “above,” and the like, another device or layer, it shall also encompass the case of yet another device or layer disposed on, over, above, and the like, the other device or layer or interposed between the one device or layer and the other device or layer. On the contrary, when one device or layer is described to be “directly on,” “directly over,” “directly above,” and the like, another device or layer, it shall mean that no other device or layer is interposed between the one device or layer and the other device or layer.

An expression such as “comprising” or “including” is intended to designate a characteristic, a number, a step, an operation, an element, a part or combinations thereof, and shall not be construed to preclude any possibility of presence or addition of one or more other characteristics, numbers, steps, operations, elements, parts or combinations thereof.

Unless otherwise defined, all terms, including technical terms and scientific terms, used herein have the same meaning as how they are generally understood by those of ordinary skill in the art to which the present disclosure pertains. Any term that is defined in a general dictionary shall be construed to have the same meaning in the context of the relevant art, and, unless otherwise defined explicitly, shall not be interpreted to have an idealistic or excessively formalistic meaning.

Terms such as “first” and “second” may be used in describing various elements, but the above elements shall not be restricted to the above terms. The above terms may be used only to distinguish one element from the other. For instance, the first element may be named the second element, and vice versa, without departing the scope of claims of the present disclosure. Unless clearly used otherwise, any expressions in a singular form may include a meaning of a plural form. The term “and/or” shall include the combination of a plurality of listed items or any of the plurality of listed items.

In embodiments of the present disclosure, directions labeled as first through third directions DR1 - DR3 may be defined. The first direction DR1 may be parallel to one side of a first substrate SUB1. The second direction DR2 may intersect the first direction DR1 and may be parallel to one side of the first substrate SUB1. The third direction DR3 may be perpendicular to one side of the first substrate SUB1. In embodiments of the present disclosure, the phrase “in a plan view” refers to viewing along the third direction DR3.

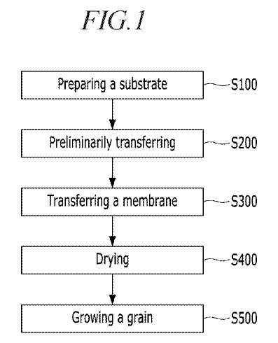

FIG. 1 is a flow chart of a method for manufacturing a free-standing membrane according to one embodiment of the present disclosure.

Referring to FIG. 1, a method for manufacturing a free-standing membrane according to one embodiment of the present disclosure may include preparing a substrate S100, preliminarily transferring S200, transferring a membrane S300, drying S400, and growing a grain S500.

However, the present disclosure is not necessarily limited thereto, and some of the described steps may be omitted.

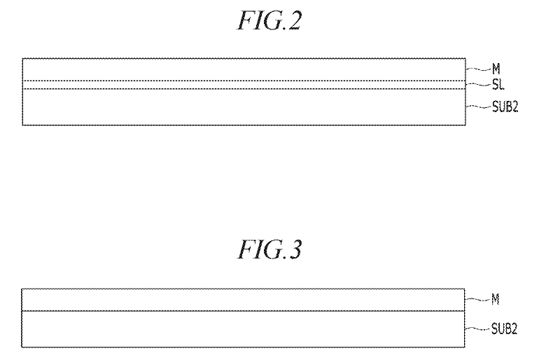

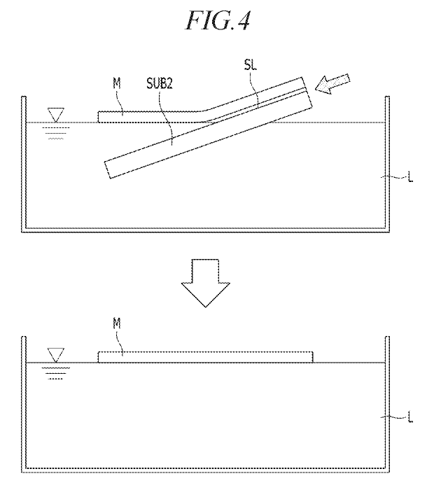

FIG. 2 is an illustration showing a second substrate on which a membrane is disposed on one surface thereof, and FIG. 3 is a modified example of FIG. 2.

Referring to FIG. 2, in the preparing a substrate S100, a membrane M may be formed on one side of the second substrate SUB2.

As an example, a sacrificial layer SL may be disposed between the second substrate SUB2 and the membrane M.

The second substrate SUB2 may be used to transfer the membrane M onto surface of a liquid.

When the second substrate SUB2 to which the membrane M is attached is pushed into a liquid, excessive bending deformation of the second substrate SUB2 may occur due to failure to overcome surface tension of the liquid, and the membrane M may not be smoothly separated from the second substrate SUB2. Accordingly, the second substrate SUB2 may be manufactured with a sufficient thickness or made of a material having a high elastic modulus to prevent such deformation.

In an experimental example of the present disclosure, a silicon substrate was used as the second substrate SUB2, but the present disclosure is not necessarily limited thereto. The second substrate SUB2 may be made of, for example, metal or plastic.

When the second substrate SUB2 is pushed into a liquid, the sacrificial layer SL may be dissolved by the corresponding liquid whereby the membrane M is separated from the second substrate SUB2 and transferred a surface of a liquid.

The sacrificial layer SL may include a material that can be readily dissolved in the corresponding liquid, such as a polymer material, metal, or ceramic.

As an example, the sacrificial layer SL may include at least one polymer material, such as polystyrene sulfonate (PSS), and poly(3,4-ethylenedioxythiophene) polystyrene sulfonate (PEDOT:PSS).

In this case, the liquid may be a deionized water-based solvent capable of readily dissolving a polymer material.

However, the present disclosure is not necessarily limited thereto, and an aqueous solution or an alcohol-based solvent may be used.

Such a polymer sacrificial layer may be formed by applying a coating solution on the second substrate SUB2. The application of a coating solution may be performed by a spin coating method, but the present disclosure is not necessarily limited thereto. Depending on a concentration, methods, such as drop casting, or blade coating method may be utilized.

As another example, the sacrificial layer SL may include metal or ceramic. In this case, the liquid may be an acidic aqueous solution capable of readily dissolving, for example, metal. For example, the liquid may be manufactured using ammonium persulfate, or in some cases using a strong acid, such as hydrochloric acid (HCl), or sulfuric acid.

Such metallic or ceramic sacrificial layer may be formed on the second substrate SUB2 utilizing techniques used for a semiconductor process, such as physical vapor deposition (PVD), chemical vapor deposition (CVD), electroplating, spin-on-glass (SOG) techniques.

The membrane M may be formed through deposition or application of a metal material, such as gold (Au), silver (Ag) or copper (Cu), on the sacrificial layer SL. However, the present disclosure is not necessarily limited thereto, and the membrane M may be formed with other types of metal, ceramic, or polymer material.

The membrane M may be an ultrathin film membrane having a thickness of a nanoscale. For example, a thickness of the membrane M may be greater than or equal to 30 nm and less than or equal to 200 nm.

Referring to FIG. 3, the membrane M may be directly formed on the second substrate SUB2 without a sacrificial layer.

The sacrificial layer may be omitted, as in the modified example of the present disclosure, provided that the membrane M can be smoothly separated from the second substrate SUB2 without a sacrificial layer and transferred onto surface of the liquid when the second substrate SUB2 is pushed into a liquid.

In the modified example, the second substrate SUB2 may be a silicon substrate, and the membrane M may be formed through deposition or application of gold (Au) on the second substrate SUB2.

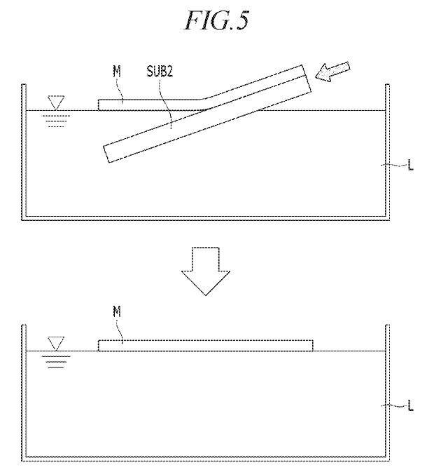

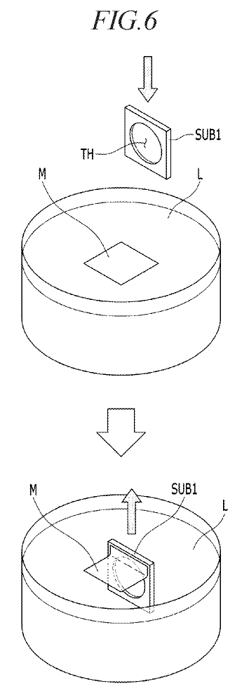

FIG. 4 is an illustration for explaining a preliminary transfer step of a membrane shown in FIG. 2, and FIG. 5 is an illustration for explaining a preliminary transfer step of a membrane shown in FIG. 3.

Referring to FIG. 4 and FIG. 5, in the preliminarily transferring S200, the second substrate SUB2 to which the membrane M is attached may be pushed into the liquid L, and the membrane M may be separated from the second substrate SUB2 and transferred onto surface of the liquid L.

For example, the second substrate SUB2 may be pushed into the liquid L at an inclined angle relative to surface of the liquid L.

As a result, separation and transfer of the membrane M may proceed from a lower portion toward an upper portion of the membrane M.

When the membrane M is completely transferred onto the surface of the liquid L, the membrane M may be in a free-standing state, not directly supported by a substrate, as shown in the drawing.

As described above, the liquid L may include one of deionized water-based solvent, aqueous solution, alcohol-based solvent or acidic aqueous solution, but the present disclosure is not necessarily limited thereto.

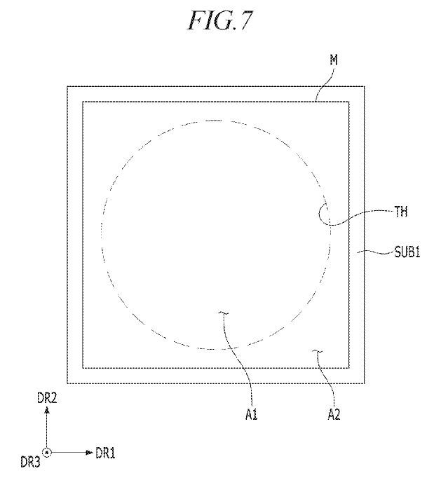

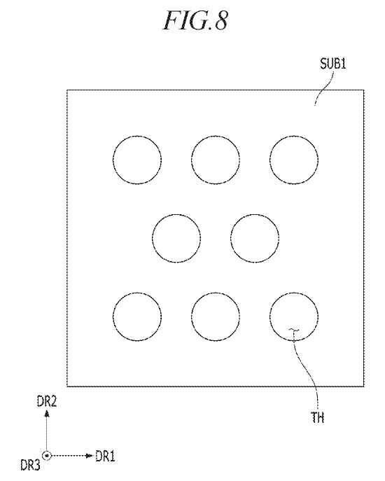

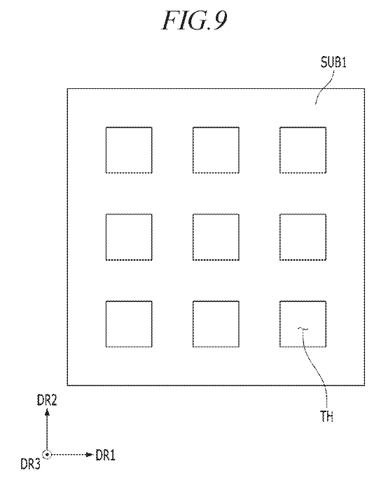

FIG. 6 and FIG. 7 are illustrations for explaining a membrane transfer step for the membrane transferred onto the surface of the liquid. FIG. 8 is a modified example of the first substrate shown in FIG. 6, and FIG. 9 is another modified example of the first substrate shown in FIG. 6.

Referring to FIG. 6 and FIG. 7, in the transferring a membrane S300, the membrane M may be transferred onto the first substrate SUB1 provided with a penetration hole TH to provide a free-standing area A1 in the membrane M.

According to one embodiment of the present disclosure, after lowering the first substrate SUB1 into the liquid L and then lifting it up in a direction perpendicular to the surface of the liquid L, the membrane M in a free-standing state on the surface of the liquid L may be transferred onto the first substrate SUB1. That is, the membrane M in a free-standing state on the surface of the liquid L may be scooped up by the first substrate SUB1 to be transferred onto the first substrate SUB1.

Here, a transfer device (not shown) may be utilized to transfer the first substrate SUB1 in a vertical direction.

The first substrate SUB1 may be in an upright state so as to extend in a direction perpendicular to the surface of the liquid L in the transferring a membrane.

As a result, the membrane M may be transferred onto the first substrate SUB1, which is a perforated substrate, without damage.

When excessive bending deformation occurs due to the surface tension of the liquid L, transfer of the membrane M onto the first substrate SUB1 may not be smoothly performed. The first substrate SUB1 may be manufactured with a sufficient thickness or made of a material having a high elastic modulus to prevent the above.

In one experimental example of the present disclosure, a thin plate with well-controlled surface roughness, for example, a nickel thin plate having a thickness of 500 mm, was used as the first substrate SUB1.

However, the present disclosure is not necessarily limited thereto, the first substrate SUB1 may be made of a silicon substrate used, for example, for a semiconductor process, metal, such as copper, or plastic.

In the first substrate SUB1, a penetration hole TH may be formed, the penetration hole TH penetrating one side and another side, which is an opposite side of the one side, of the first substrate SUB1.

The penetration hole TH may be formed through various processing methods. For example, a processing method, such as laser processing, water jet processing, milling, turning, and chemical etching, may be used.

In one embodiment of the present disclosure, the membrane M was described as being transferred onto the surface of the liquid L before being transferred onto the first substrate SUB1. However, the present disclosure is not necessarily limited thereto.

In the membrane M transferred onto the first substrate SUB1, a free-standing area A1 and a substrate support area A2 may be provided.

The free-standing area A1 may be an area overlapping with the penetration hole TH of the first substrate SUB1 in a planar view.

That is, in the membrane M, a free-standing area A1 may be provided, the free-standing area A1 not directly supported by the first substrate SUB1.

According to one experimental example of the present disclosure, it could be confirmed that the free-standing area A1 having a diameter of up to 10 cm could be formed without damage in the membrane M having a thickness of 30 nm to 200 nm.

The substrate support area A2 may be an area overlapping with one side of the first substrate SUB1 in a planar view.

The substrate support area A2 may not overlap with the penetration hole TH provided in the first substrate SUB1 in a planar view.

The substrate support area A2 may be disposed to surround the free-standing area A1 in a planar view.

For example, the membrane M may be transferred onto the first substrate SUB1 to cover the penetration hole TH of the first substrate SUB1 in the transferring a membrane S300.

The membrane M may be attached to the first substrate SUB1 in the substrate support area A2 by van der Waals force acting between the first substrate SUB1 and the membrane M.

Referring to FIG. 8 and FIG. 9, a size of the first substrate SUB1, and a number and shape of penetration holes TH provided in the first substrate SUB1 may be variously designed without limitation.

In one or more embodiments, when the membrane M is transferred from the surface of the liquid L onto the first substrate SUB1, some liquid L may remain on the membrane M or the first substrate SUB1. Such residual liquid L may rapidly vaporize during a subsequent heat treatment process, which may damage the membrane M. Accordingly, the drying S400 may be required prior to the heat treatment process.

In one experimental example of the present disclosure, the first substrate SUB1 onto which the membrane M is transferred was transferred on a hot plate or put into an oven to be heated to a second temperature, for example, about 50 ℃, lower than a first temperature, which is a temperature in a heat treatment process, thereby shortening a process time.

In one or more embodiments, when the membrane M is transferred on the first substrate SUB1 from the surface of the liquid L, the membrane M may be attached to an inner side of the first substrate SUB1defining the penetration hole TH by surface tension of residual liquid L. As the residual liquid L evaporates during a drying process, the membrane M may be separated from the inner side of the first substrate SUB1, and a wrinkle may occur in the free-standing area A1.

Subsequently, in the growing a grain S500, a size of a grain may increase in the free-standing area A1 of the membrane M.

The growing a grain S500 may include a heat treatment process, in which the membrane M is heated and then cooled.

The heat treatment process may be performed utilizing a hot plate or using an oven, a furnace or electrical Joule heating.

Although it is described in one embodiment of the present disclosure that a grain is grown through a heat treatment, the present disclosure is not necessarily limited thereto. Various alternative processes capable of growing a size of a grain in the free-standing area A1 may also be applied.

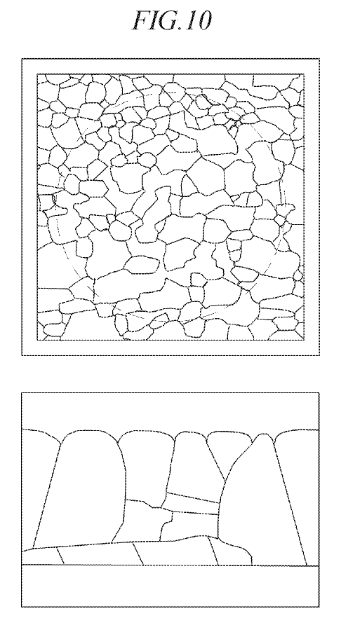

FIG. 10 through FIG. 12 are illustrations for explaining a grain growth mechanism in the growing a grain.

FIG. 10 through FIG. 12 respectively illustrate plan views of a first substrate SUB1 to which a membrane M is attached, and cross-sectional views of a membrane M in a free-standing area A1. For ease of understanding, boundaries of grains forming the membrane M are also shown.

In experimental examples shown in FIG. 10 through FIG. 12, a silicon substrate is used as the first substrate SUB1.

Referring to FIG. 10, it could be confirmed that a size of a grain in the membrane M transferred onto the first substrate SUB1 is very small before undergoing the growing a grain S500, for example, a heat-treatment process.

Referring to FIG. 11 and FIG. 12, the first substrate SUB1 to which the membrane M is attached may undergo a heat treatment process.

In an experimental example of the present disclosure, the silicon substrate to which a gold thin film was attached was heated from room temperature RT to a first temperature, for example, about 250 ℃, and then gradually cooled to room temperature.

FIG. 11 is an illustration of a state in which the substrate is heated to the first temperature, and FIG. 12 is an illustration of a state in which the substrate is cooled to room temperature.

After such a heat-treatment process, it could be confirmed that the size of a grain in the membrane M in the free-standing area A1 increased.

As a result, an electrical resistance of the membrane M decreased by about 25 % after the heat treatment process.

In addition, it could also be confirmed that the grains of the membrane M in the free-standing area A1 were aligned in a predetermined direction, for example, the 111 direction, after the heat-treatment process.

Unlike heat-treating a membrane M provided with a free-standing area A1 as in the embodiment of the present disclosure, it was confirmed in a comparative experimental example, where a membrane fully attached to a substrate was heat-treated, that effect of grain size increase was minimal and that when the temperature exceeded a certain level, the grains completely disappeared.

Particularly, the comparative experimental example was conducted using a silicon substrate without formation of a penetration hole, rather than a perforated substrate.

As a result, it could be confirmed that the membrane fully attached to the silicon substrate without formation of a penetration hole did not delaminate even at a heating temperature of around 300 ℃, and that when the temperature reached about 400 ℃ to 500 ℃, the membrane was completely diffused into silicon and the grains disappeared.

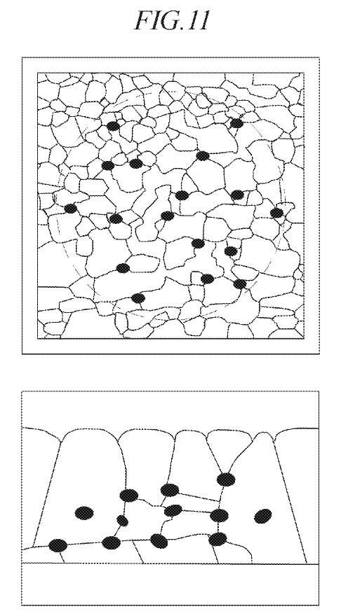

FIG. 13 is an illustration for explaining effect of wrinkle improvement in a membrane due to the heat-treatment process.

Referring to FIG. 13, the membrane M may develop a wrinkle in the free-standing area A1 during the transfer onto the first substrate SUB1, as shown in the first image, and, a wrinkle may also form during the drying S400, as described above and shown in the second image.

However, it could be confirmed that a wrinkle in the free-standing area A1 is flattened during the heat treatment process for grain growth, as shown in the third image.

When a wrinkle is flattened as above, the membrane M may become significantly robust compared to its previous state.

That is, a mechanical strength of the membrane M may be improved.

As a result, formation of a functional layer may be allowed through, for example, spin coating, electroplating, or sputtering on a free-standing area A1 of a membrane M by using the membrane M as a base substrate.

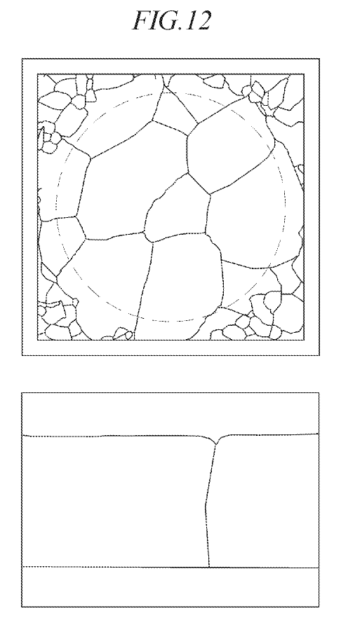

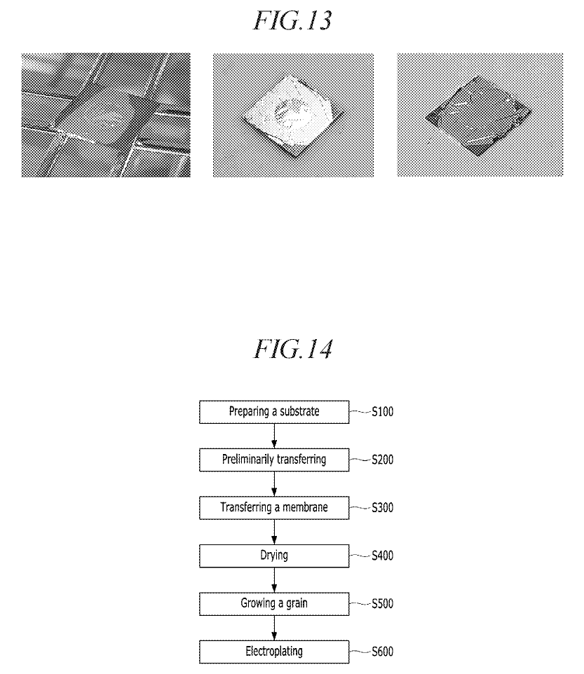

FIG. 14 is a flow chart showing a method for forming an electroplated layer using a free-standing membrane according to one embodiment of the present disclosure. FIG. 15 is an illustration for explaining a step of electroplating in FIG. 14.

Referring to FIG. 14, the method for forming an electroplated layer using a free-standing membrane according to one embodiment of the present disclosure may include preparing a substrate S100, preliminarily transferring S200, transferring a membrane S300, drying S400, growing a grain S500, and electroplating S600. However, the present disclosure is not necessarily limited thereto, and some of the described steps may be omitted.

In the method for forming an electroplated layer according to one embodiment of the present disclosure, the preparing a substrate S100, the preliminarily transferring S200, the transferring a membrane S300, the drying S400, and the growing a grain S500 may be substantially identical with the preparing a substrate S100, the preliminarily transferring S200, the transferring a membrane S300, the drying S400, and the growing a grain S500 in the method for manufacturing a free-standing membrane described in relation with FIG. 1 through FIG. 13. Accordingly, detailed descriptions thereof will be omitted.

In the electroplating S600, an electroplated layer may be formed on the free-standing area A1 after the heat treatment process.

In an experimental example of the present disclosure, the first substrate SUB1 to which the membrane M was attached, and a copper substrate CS were immersed in a solution, and a voltage was applied to perform electroplating.

As a result, an electroplated layer including copper may be formed on the membrane M.

However, the present disclosure is not necessarily limited thereto, and the electroplating may be performed using a conductive substrate including a conductive material different from a copper substrate.

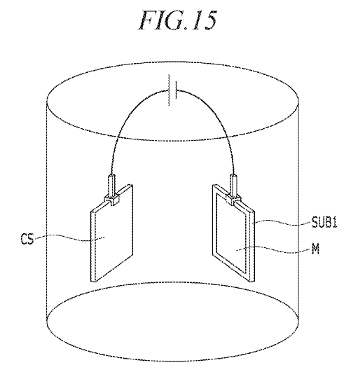

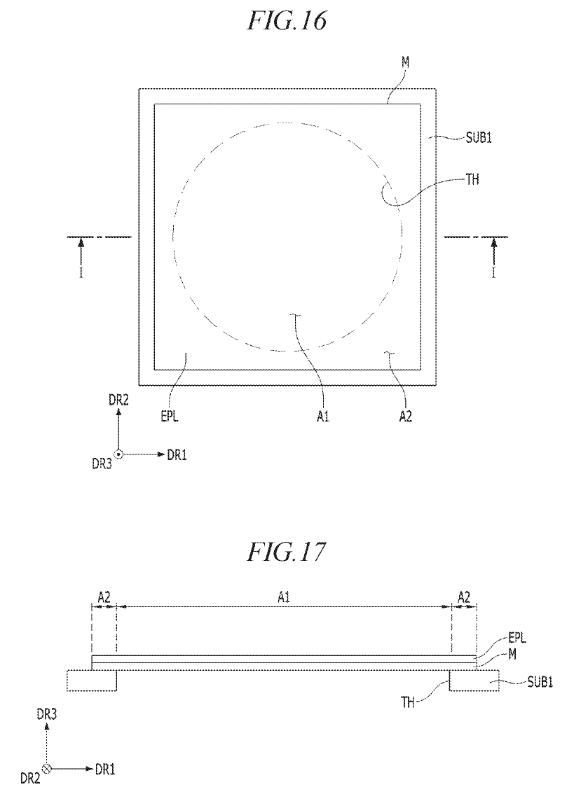

FIG. 16 is an illustration showing a first substrate with formation of an electroplated layer on a membrane through electroplating, and FIG. 17 is a cross-sectional view taken along the I-I line shown in FIG. 16.

Referring to FIG. 16 and FIG. 17, a free-standing area A1 and a substrate support area A2 may be defined in a membrane M transferred onto a first substrate SUB1 provided with a penetration hole TH.

The free-standing area A1 may be an area of the first substrate SUB1 overlapping with the penetration hole TH in a planar view.

The substrate support area A2 may be an area overlapping with one side of the first substrate SUB1 in a planar view.

The substrate support area A2 may not overlap with the penetration hole TH provided in the first substrate SUB1 in a planar view.

As a layer formed by electroplating, the electroplated layer EPL may be disposed on the membrane M.

The electroplated layer EPL may cover the free-standing area A1 and the substrate support area A2.

In the free-standing area A1 of the membrane M, the grains may grow through the described heat treatment process to be aligned in a predetermined direction. Accordingly, when an electroplated layer EPL is formed on the membrane that has undergone the grain growth process as above, the grains forming an electroplated layer EPL (i.e., metal crystals) may also form with a large size and be aligned in a predetermined direction, for example, substantially the same direction as the grains in the free-standing area A1 of the membrane M. As a result, the electroplated layer may exhibit low electrical resistance, excellent corrosion resistance, and a crystal structure aligned in a predetermined direction, similar to single-crystal copper.

The electroplated layer EPL may include copper, but the present disclosure is not necessarily limited thereto. The electroplated layer EPL may include other conductive materials, such as gold or silver.

Hitherto, certain preferred embodiments of the present disclosure have been described above, but these are merely exemplary and are not intended to limit the present disclosure. Those skilled in the art to which the present disclosure pertains may make various modifications and changes to the embodiments by adding, changing, deleting, or adding certain elements, without departing from the scope of the technical ideas of the present disclosure as set forth in the claims, and such modifications and changes should also be regarded as being within the scope of the present disclosure.

What is claimed is:

1. A method for manufacturing a free-standing membrane, the method comprising:
transferring a membrane onto a first substrate provided with a penetration hole to provide a free-standing area in the membrane, the free-standing area overlapping with the penetration hole in a planar view; and
growing a grain to increase a size of the grain in the free-standing area.

2. The method for manufacturing a free-standing membrane of claim 1,
wherein in the transferring a membrane, the membrane is transferred onto the first substrate to cover the penetration hole.

3. The method for manufacturing a free-standing membrane of claim 1,
wherein after the transferring a membrane, the free standing area and a substrate support area are provided in the membrane, the substrate support area overlapping with the first substrate in a planar view.

4. The method for manufacturing a free-standing membrane of claim 1,
wherein the growing a grain comprises a heat process, in which the membrane is heated and then cooled.

5. The method for manufacturing a free-standing membrane of claim 4,
wherein a size of the grain in the free-standing area is increased by the heat treatment process, and the grains in the free-standing area are aligned in a pre-determined direction.

6. The method for manufacturing a free-standing membrane of claim 4, the method further comprising:
preparing a substrate, in which a second substrate is prepared, the membrane disposed on one side of the second substrate; and
preliminarily transferring, in which the second substrate is pushed into a liquid to transfer the membrane onto a surface of the liquid,
wherein in the transferring a membrane, the membrane transferred onto a surface of the liquid is scooped up by the first substrate to be transferred onto the first substrate.

7. The method for manufacturing a free-standing membrane of claim 6, the method further comprising:
drying, in which the liquid remaining on the membrane is evaporated and removed after the transferring a membrane and before the heat treatment process.

8. The method for manufacturing a free-standing membrane of claim 6,
wherein a wrinkle in the free-standing area is flattened through the heat treatment process.

9. A method for forming an electroplated layer using a free-standing membrane, the method comprising:
transferring a membrane, in which a membrane is transferred onto a first substrate provided with a penetration hole to provide a free-standing area in a membrane, the free-standing area overlapping with the penetration hole in a planar view;
growing a grain, in which a size of the grain in the free-standing area is increased by a heat treatment process; and
electroplating, in which an electroplated layer is formed on the free-standing area after the heat treatment.

10. The method for forming an electroplated layer using a free-standing membrane of claim 9,
wherein grains of the electroplated layer are aligned in a direction substantially same with that of grains of the free-standing area.
